(19) United States
(12) Patent Application Publication
(10) Pub. No.: US 2005/0056818 A1
(43) Pub. Date: Mar. 17, 2005

(54) Wheel lift attachment and method

(76) Inventor: Eric A. Harrah, Bloomfield, IN (US)

Correspondence Address: C. David Emhardt;Woodard, Emhardt, Moriarty, McNett & Henry LLP, Bank One Center/Tower, Suite 3700, 111 Monument Circle, Indianapolis, IN, 46204-5137, US

(21) Appl. No.: 10/664,520

(22) Filed: Sep. 17, 2003

(51) Int. Cl. B66F 3/00

(52) U.S. Cl. 254/133 R

(57) ABSTRACT

A method for lifting a wheel of a vehicle including placing a bracket on the nose of a lifting jack with hooks secured to the bracket by straps. The jack is cranked with the hooks in the wheel. A wheel lift attachment for use with a jack the attachment including a bracket, straps and hooks.

### BACKGROUND OF THE INVENTION

1. Field of the Invention

This invention relates to a wheel lift attachment and method.

2. Description of the Prior Art

Hand operated bumper jacks such as the one disclosed in the P. J. Harrah, U.S. Pat. No. 1,374,653 or the McIntosh U.S. Pat. No. 4,379,546 have been available for many years and have a wide range of applications. They may be used as a general purpose jack around the farm or may be mounted on a 4-wheel drive vehicle for extricating the vehicle when it becomes stuck in the mud or the like. Other applications are winching and as a come-along. It has become a problem in recent years with new vehicles that they do not have an easy place to attach the jack for lifting the vehicle. In the past the jack functioned as a bumper jack but in recent years bumpers are not the best place to use the jack for lifting a vehicle because the bumpers are not as strong as they used to be and are not as well secured to the vehicle.

### SUMMARY OF THE INVENTION

One embodiment of the invention might include a method for lifting a wheel of a vehicle the wheel having one or more openings therein. The method comprises providing a U-shaped downwardly opening bracket on the nose of the lifting jack with a strap secured to the bracket and a hook secured to the strap. The hook is hooked onto an opening of the wheel. The jack is then cranked to lift the wheel. Another embodiment of the present invention is a wheel lift attachment comprising a U-shaped bracket arranged to open downwardly. An elastomer covered block is fixed to the bracket and is adapted to abut a tire. A pair of straps are mounted on the U-shaped bracked. Finally a pair of hooks are mounted on the straps with each of the hooks of the pair mounted on a respective one of the straps.

### BRIEF DESCRIPTION OF THE DRAWINGS

FIG. 1 is a perspective view of the wheel lift attachment of the present invention.

FIG. 2 is a front elevation.

FIG. 3 is a side elevation as viewed from the right side of FIG. 2.

FIG. 4 is a side elevation as viewed from the left side.

FIG. 5 is a top plan view.

FIG. 6 is a bottom plan view.

FIG. 7 is a rear elevation.

FIG. 8 is a side elevation of a vehicle showing a step in one embodiment the method of the present invention.

FIG. 9 is a fragmentary perspective view showing a further step.

FIG. 10 is a perspective view showing still a further step.

FIG. 11 is a perspective view showing still another step.

FIG. 12 is a perspective view showing still a further step.

FIG. 13 is a perspective view showing still another step.

FIG. 14 is a perspective view showing still another step.

FIG. 15 is a side elevation of a vehicle showing still another step.

FIG. 16 is a perspective view showing still a further step.

FIG. 17 is a perspective view showing still another step.

### DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

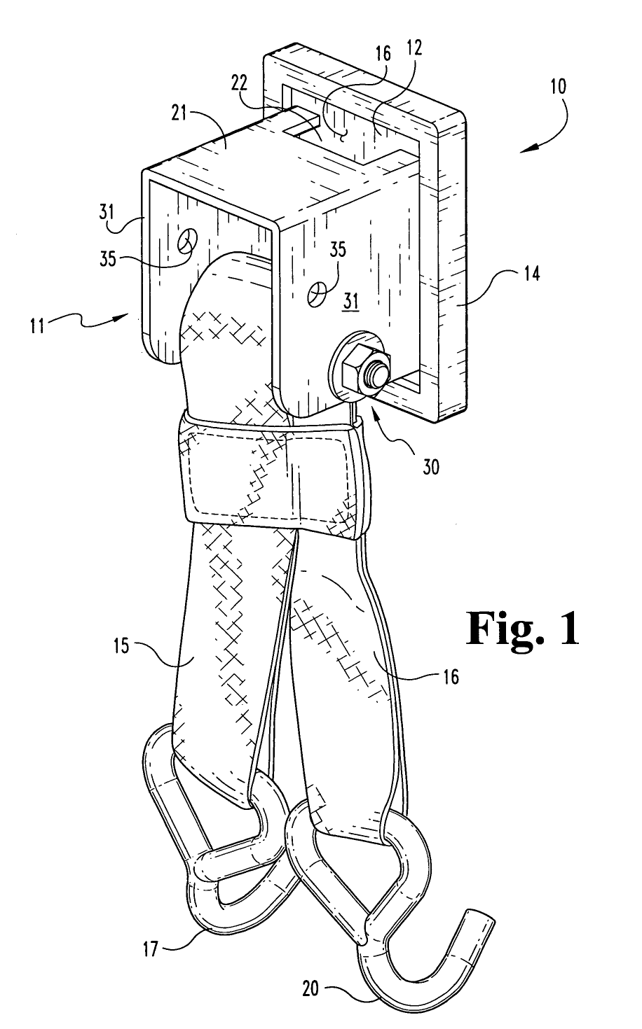

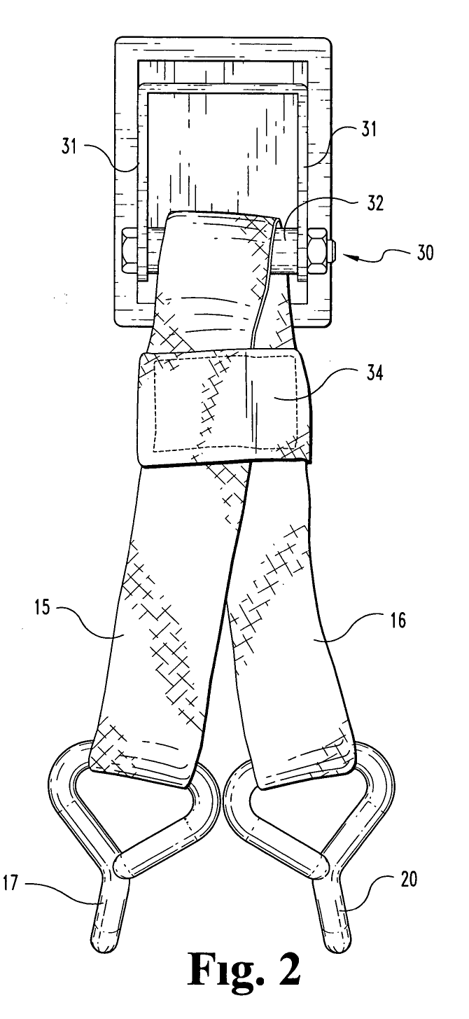

Referring to FIG. 1 there is illustrated a wheel lift attachment 10 which includes a U-shaped bracket 11 and an elastomer covered block 12 fixed to the U-shaped bracket 11. In practicing the method of the present invention the elastomer covered block 12 abuts the tire of the vehicle. The elastomer material 14 covers the face of the block the edges of the block and all but the surface 16 of the block 12 to which surface 16 the U-shaped bracket 11 is welded. A pair of straps 15 and 16 are mounted on the U-shaped bracket and a pair of hooks 17 and 20 are secured to the bracket by the straps 15 and 16.

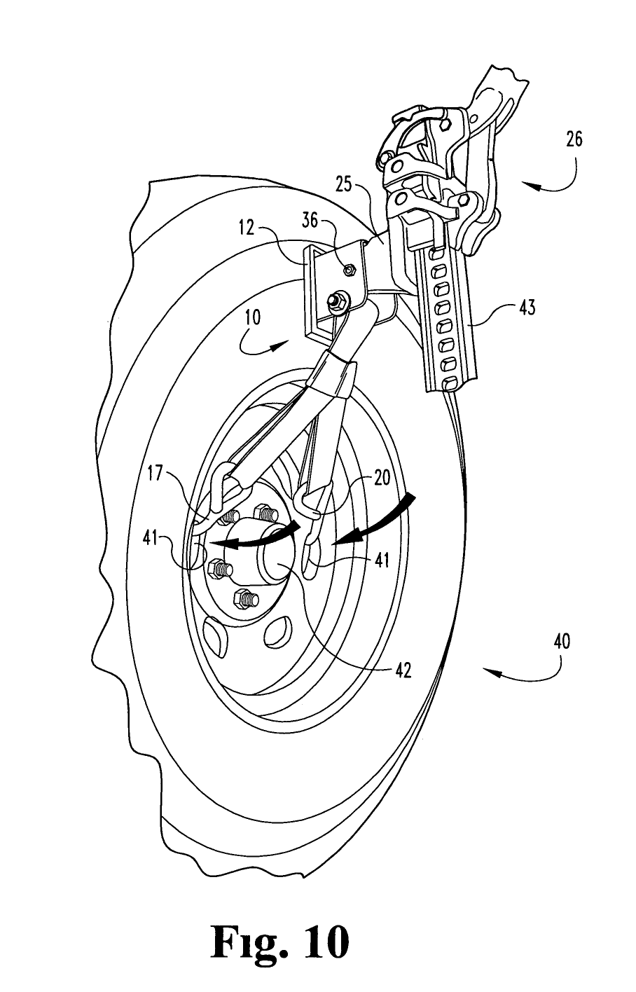

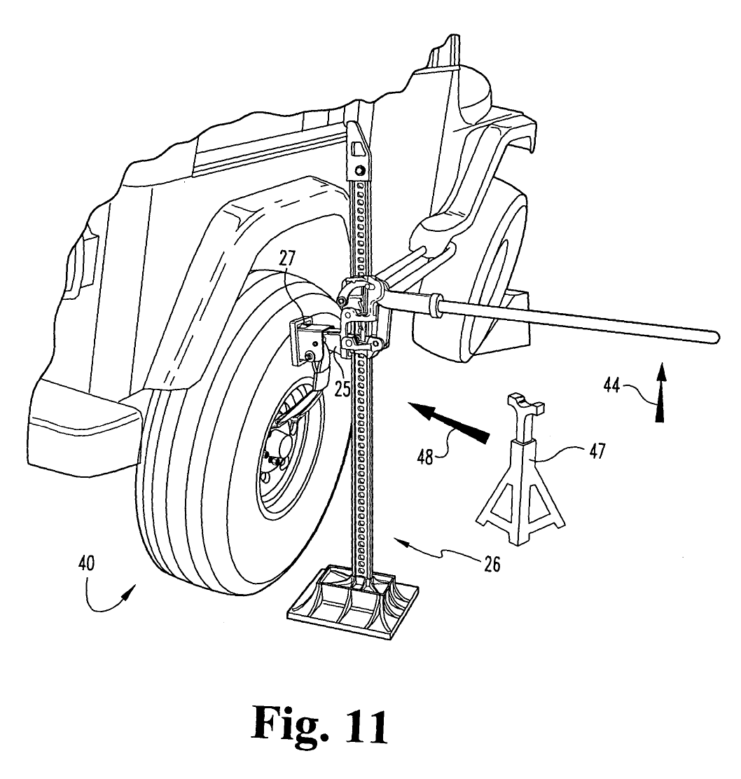

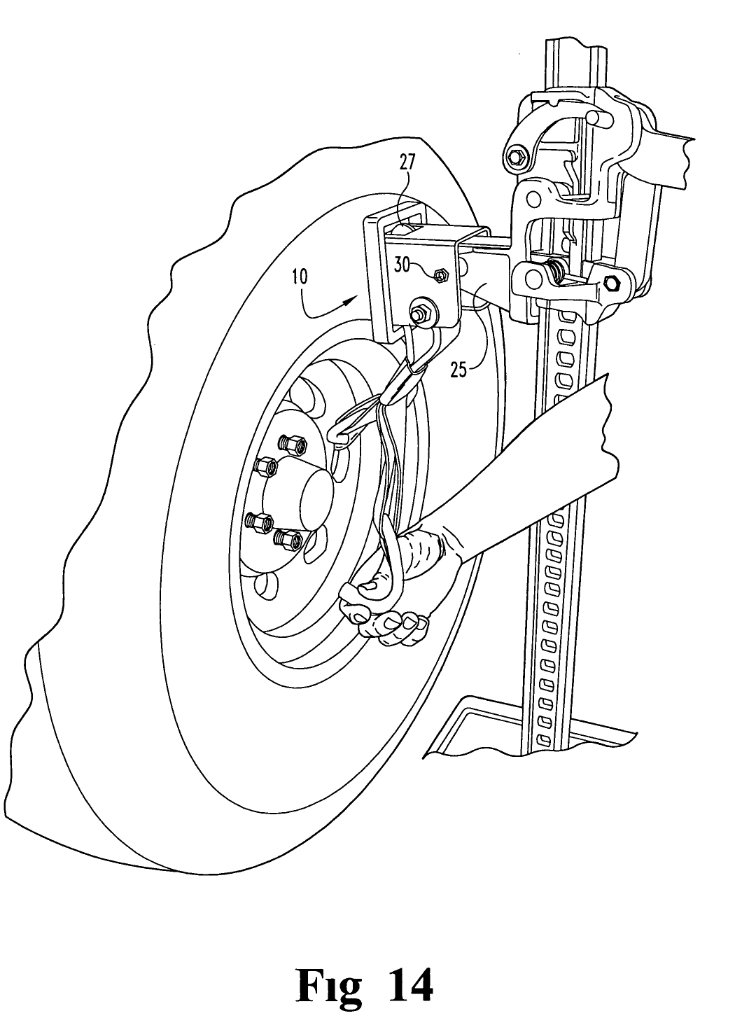

In use the bracket 11 is arranged to open downwardly and has a base 21 which has a recess 22 therein which in combination with the elastomer covered block 12 defines a slot adapted to receive the lifting nose 25 (FIGS. 10, 11, 14 and 15) of a jack 26. The nose 25 of the jack has an upturned end 27 (FIG. 11, FIG. 14) that is received within the slot or recess 22. This upturned nose is shown also in the jacks illustrated in the Harrah Patent 1,374,753 and the McIntosh Patent 4,379,546.

A bolt 30 extends through the legs 31 of the U-shaped bracket 11 and mounts the straps 15 and 16 on the bracket. A cylindrical member 32 is received on the bolt 30 between the legs and provides support for the straps 15 and 16. The straps 15 and 16 are formed of a single piece of fabric which is looped over the cylindrical member 32. An additional piece 34 of fabric is secured around the straps 15 and 16 between the hooks 17 and 20 and the cylindrical member 32. The legs 31 of the bracket 11 have holes 35 which may receive a bolt 36 securing the bracket 11 to the nose 25 of the jack 26 as shown in FIG. 10.

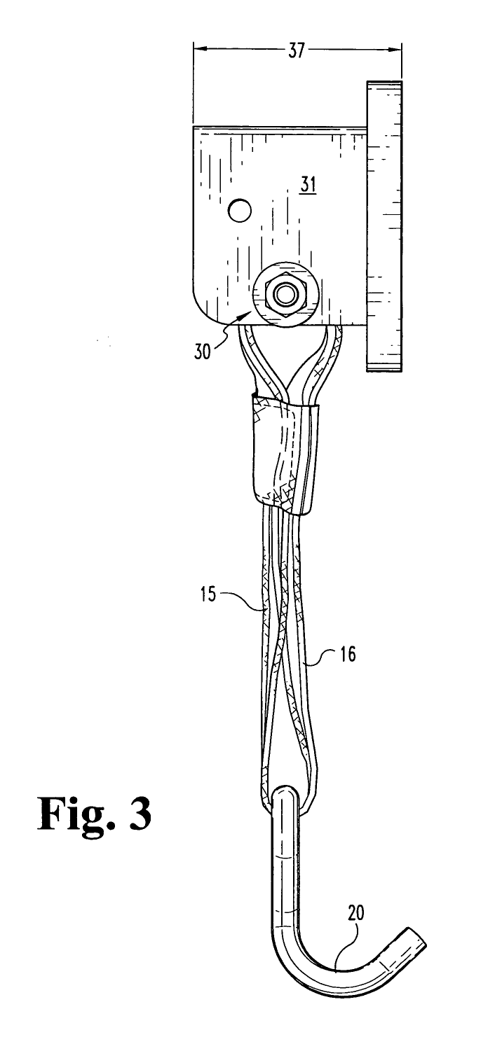

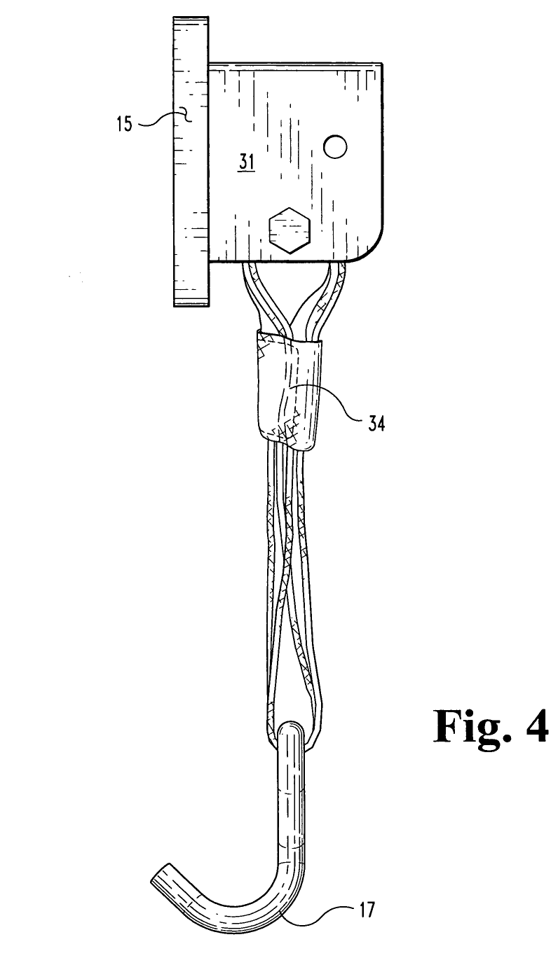

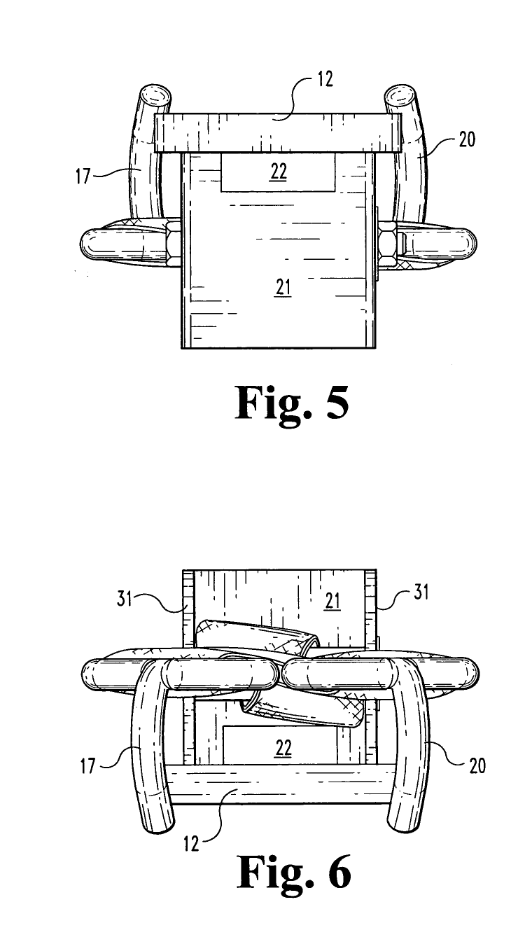

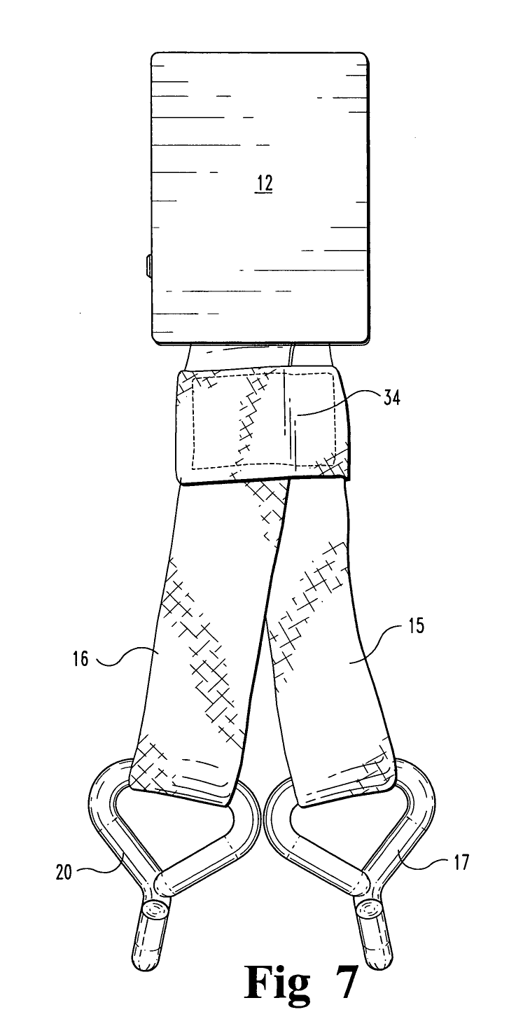

The wheel lift attachment of the present invention is preferably designed to be able to transmit 5000 pounds of lifting force with appropriate multiple safety tolerances so that the product can be advertised as capable of a 5000 pound capacity. The various elements of the wheel lift attachment should therefore be chosen so as to have that capacity. The straps 15 and 16 and the piece 34 of fabric may be any suitable flexible material having the appropriate strength but might be, for example, stitched polypropolene plastic. The hooks 17 and 20 may be any suitable rigid material having the appropriate strength but might be for example 1045 heat-treated steel. The cylindrical member 32 may be any suitable rigid material but might be, for example, polyoxymethylene plastic. The wheel lift attachment may have various appropriate dimensions that permit the jack to be placed alongside the wheel to be lifted but in one embodiment the dimension 37 (FIG. 3) is 3⅜″ with the other dimensions being scaled accordingly.

The method for lifting of a vehicle is shown in FIGS. 10 and 11. As shown in FIG. 11 the jack 26 is placed alongside of the wheel 40 and the hooks 17 and 20 are inserted into openings 41 in the wheel. When the jack is placed “alongside” the wheel 40, it should be positioned as close to the wheel 40 as possible with the bar 43 in a vertical position and the block 12 in contact with the wheel 40. In this position the force exerted by the jack on the wheel 40 will be in an almost vertical direction. The jack is then cranked as shown by the arrow 44 in FIG. 11 to raise the wheel. It will be noted that the hooks are hooked into the openings on either side of an axis taken through the axle or center 42 of the wheel. When the wheel is raised in the process described the elastomer covered block 12 bears against the tire of the wheel 40.

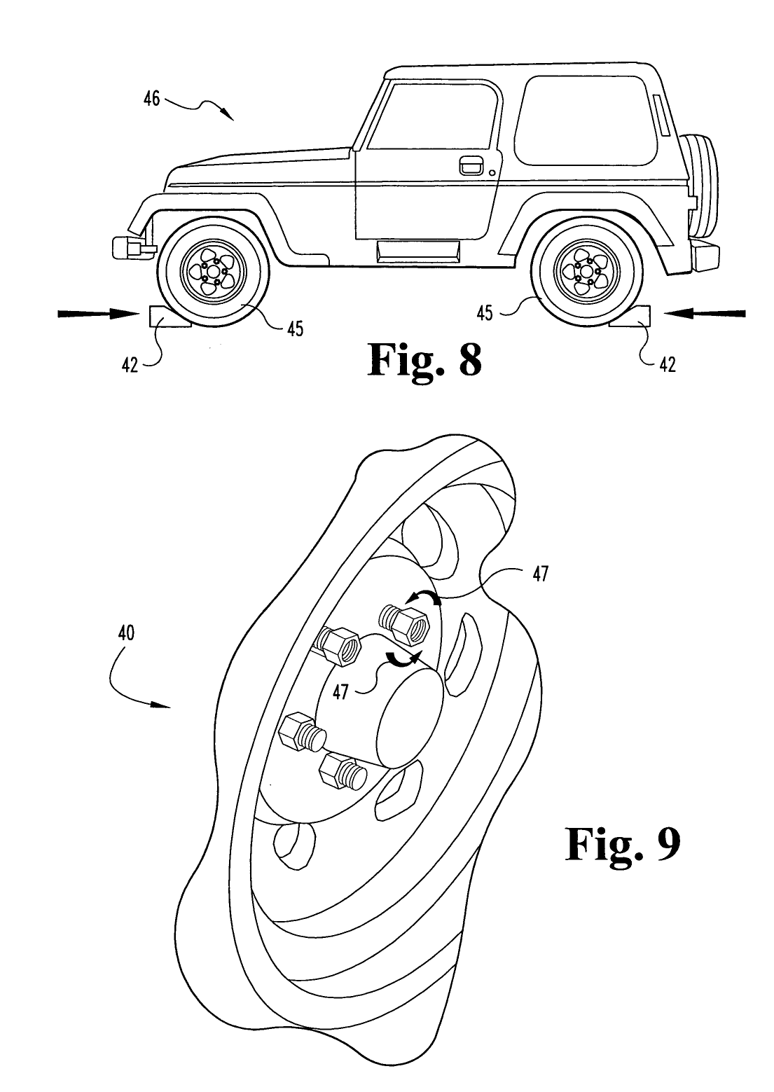

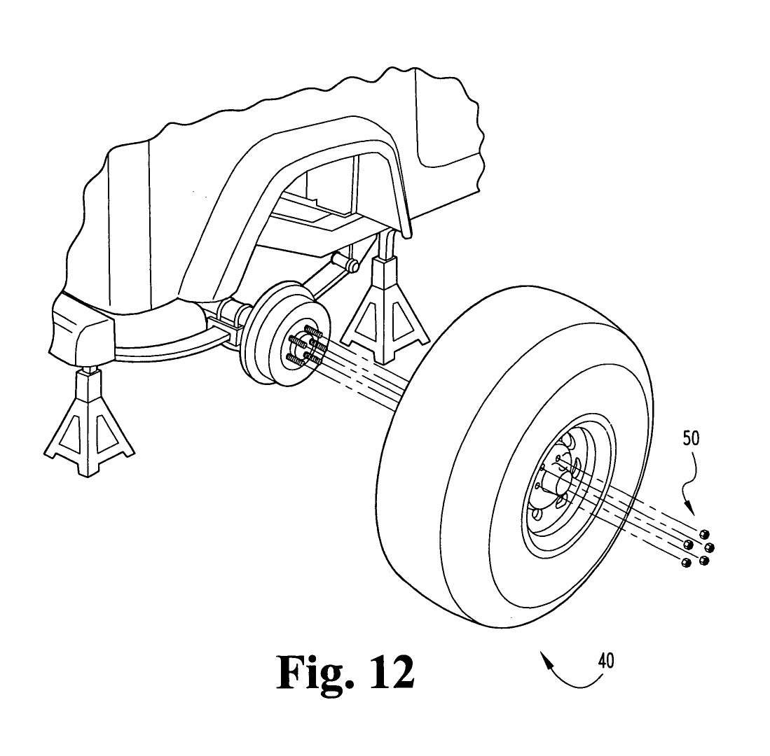

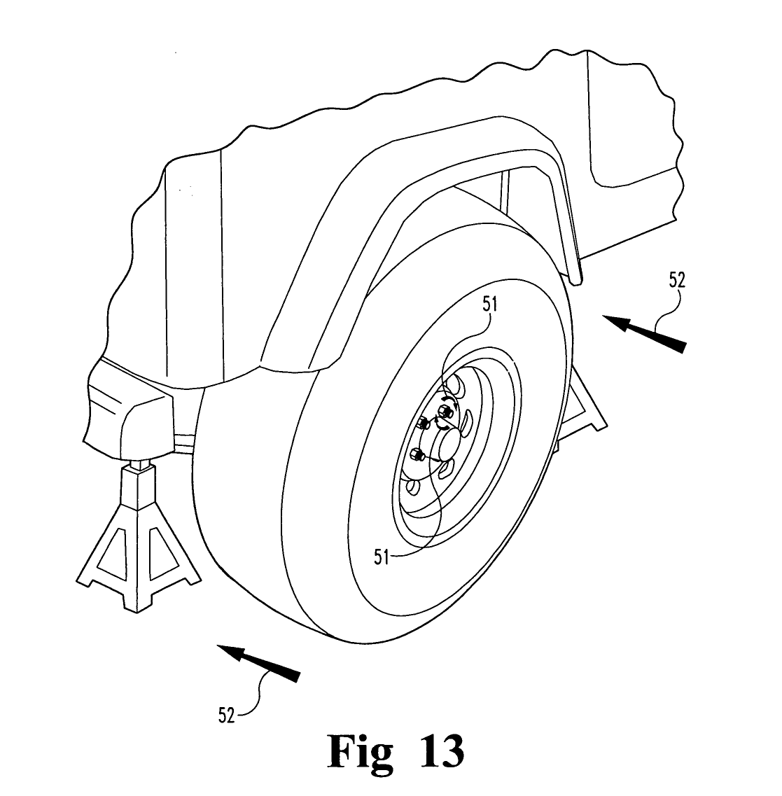

FIGS. 8-18 show the method of the present invention conducted in a safe manner. The wheel 40 (FIG. 10) is flat or needs maintenance or change for some reason. Referring to FIG. 8, chocks 42 are placed at the remaining wheels of 45 of the vehicle 46. FIG. 9 shows by arrows 47 a loosening of the lug nuts on the wheel 40 that is to be maintained by repairing the flat or other maintenance on the particular wheel. FIG. 10 shows the wheel 40 and tire that is to be repaired or maintained and shows the hooking of the hooks 17 and 20 into openings 41 in the wheel. Prior to such hooking, the jack 26 is placed alongside the wheel and the bracket 11 is placed on the lifting nose 25 of the jack with the end 27 projecting into the slot defined by the recess 22 and block 12 and the U-shaped bracket arranged to open downwardly. FIG. 11 shows the step of cranking the jack to raise the wheel high enough to position appropriate blocks or jack stands such as the jack stand 47 under the vehicle. The arrow 48 represents such positioning of the jack stand. FIG. 11 also represents lowering the jack so as to represent the supporting of the vehicle on blocks or jack stands. Care should be taken to make sure that the jack stand 47 or blocks support the vehicle sufficiently high enough to accommodate a fully inflated tire after repair or replacement has been accomplished. FIG. 12 shows removing of the lug nuts 50 on the wheel 40 from the vehicle. The wheel/tire maintenance is then performed so as to repair the flat or replace the tire and then the fully inflated tire and wheel are placed back on the vehicle and the lug nuts snugged back as shown in FIG. 13 by the arrows 51. The arrows 52 represent the movement of the wheel back onto the projecting threaded members prior to replacing of the lug nuts.

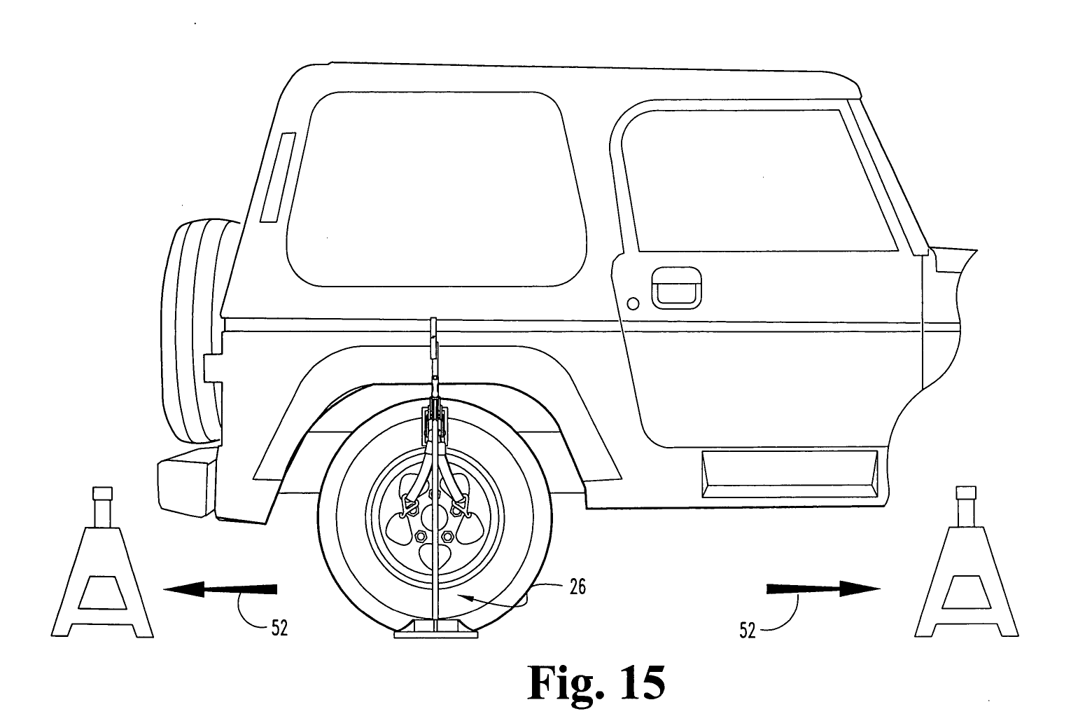

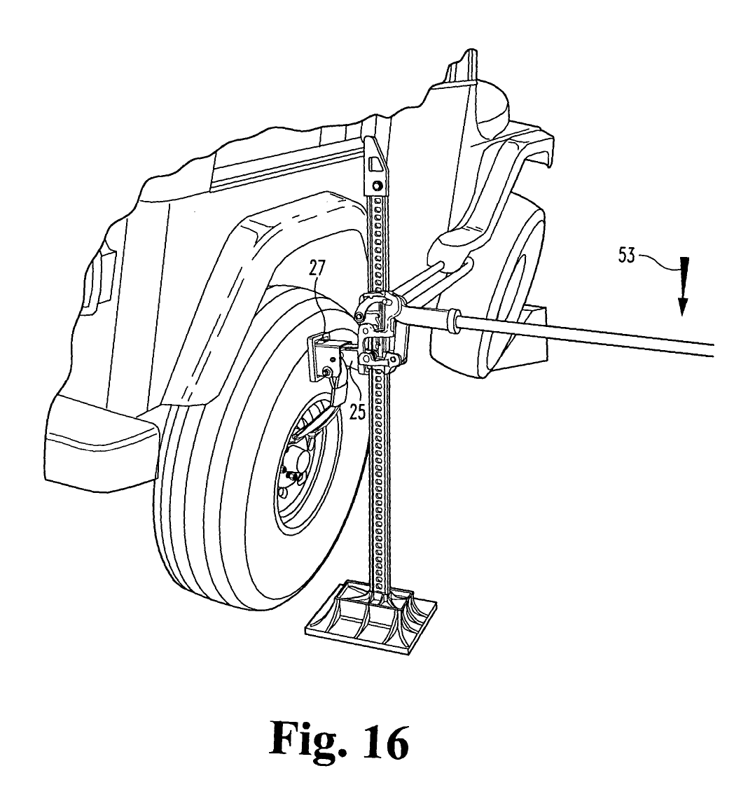

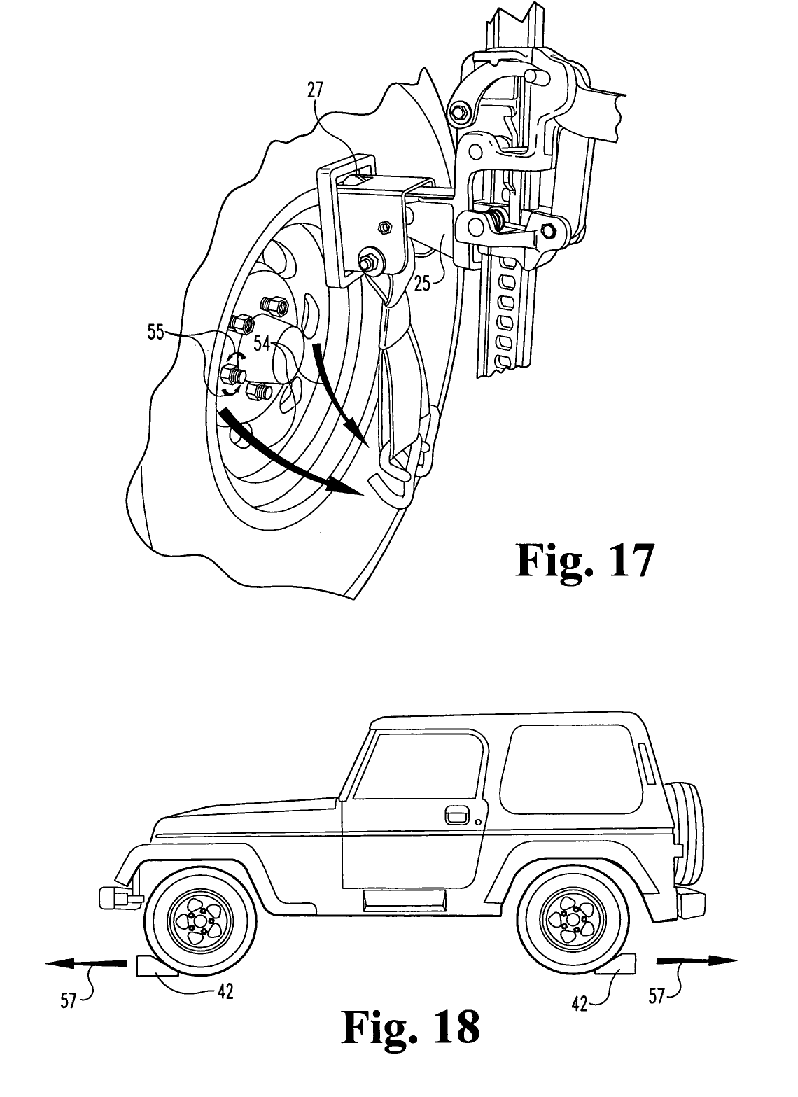

The wheel lift attachment 10 is then again secured to the wheel as shown in FIGS. 14 and 15 and then jack is operated to lift the wheel and vehicle off of the blocks or jack stands. As shown by the arrows 52 in FIG. 15 the jack stands are removed from the supporting of the vehicle. Finally as shown in FIG. 16 the jack is operated (arrow 53) to lower the wheel and cause the wheel to support the vehicle on the ground. FIG. 17 represents by arrows 54 the removal of the hooks and the wheel lift attachment from connection to the wheel. The lug nuts are then tightened as represented by the arrows 55. FIG. 18 shows and represents by arrows 57 the removal of the chocks 42 from the remaining wheels.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A wheel lift attachment comprising
(a) a U-shaped bracket arranged to open downwardly
(b) an elastomer covered block fixed to said bracket and adapted to abut a tire
(c) a pair of straps mounted on said U-shaped bracket
(d) and a pair of hooks, each of the hooks of said pair mounted on a respective one of said straps.

2. The wheel lift attachment of claim 1 wherein said bracket has a base and said base has a recess therein which, in combination with said block, defines a slot adapted to receive the lifting nose of a jack.

3. The wheel lift attachment of claim 1 additionally comprising a bolt extending through said bracket and mounting said straps on said bracket, said U-shaped bracket having two legs through which said bolt extends, a cylindrical member received on said bolt between said legs and providing support for said straps, said straps being formed of a single piece of fabric which is looped over said cylindrical member, and an additional piece of fabric secured around said straps between said hooks and said cylindrical member.

4. The wheel lift attachment of claim 3 wherein said bracket has a base and said base has a recess therein which, in combination with said block, defines a slot adapted to receive the lifting nose of a jack.

5. The wheel lift attachment of claim 4 wherein said legs of said bracket have holes adapted to receive a bolt for securing said bracket to the nose of a lifting jack.

6. A method for lifting a wheel of a vehicle, said wheel having one or more openings therein which comprises:
(a) providing a U-shaped downwardly opening bracket on the nose of a lifting jack with a strap secured to the bracket and a hook secured to the strap
(b) hooking the hook on an opening of the wheel
(c) and cranking the jack to lift the wheel.

7. The method of claim 6 additionally comprising the additional step of placing the jack alongside of the wheel prior to hooking the hook on an opening of the wheel.

8. The method of claim 7 additionally comprising prior to cranking the jack
(a) providing a second strap secured to the bracket and a second hook secured to the second strap
(b) and also prior to cranking the jack hooking the second strap on an opening of the wheel.

9. A method for performing maintenance on a first wheel of a vehicle which comprises
(a) chocking the remaining wheels of the vehicle
(b) loosening the lug nuts on the first wheel
(c) providing a U-shaped downwardly opening bracket on the nose of a lifting jack with a pair of straps secured to the bracket and a pair of hooks secured to the straps
(d) placing the jack alongside of the first wheel
(e) hooking the hooks on openings in the first wheel
(f) cranking the jack to lift the first wheel to a position sufficiently high enough to position blocks or jack stands under the vehicle adjacent to the first wheel with the first wheel in a fully maintained and repaired condition.
(g) positioning blocks or jack stands under the vehicle adjacent the first wheel
(h) cranking the jack to lower the vehicle onto the blocks or jack stands
(i) removing, maintaining and replacing the first wheel on the vehicle
(j) snugging the lug nuts
(k) placing the jack alongside the first wheel
(l) hooking the hooks on openings in the first wheel.
(m) cranking the jack up to a level that lifts the first wheel and vehicle to a height that allows the blocks or jack stands to be removed from under the vehicle
(n) removing the blocks or jack stands
(o) jacking the vehicle down
(p) removing the hooks from the wheel
(q) tightening the lug nuts
(r) and removing the chocks from the remaining wheels.
